(19) United States
(12) Patent Application Publication
(10) Pub. No.: US 2022/0139219 A1
(43) Pub. Date: May 5, 2022

(54) SIGNAL LIGHT CONTROL METHOD, APPARATUS, AND SYSTEM

(71) Applicant: Apollo Intelligent Connectivity (Beijing) Technology Co., Ltd., Beijing (CN)

(72) Inventors: CHUANG WANG, BEIJING (CN); GAO YU, BEIJING (CN); MINGZHI CHEN, BEIJING (CN); CHI ZHANG, BEIJING (CN)

(21) Appl. No.: 17/577,309

(22) Filed: Jan. 17, 2022

(30) Foreign Application Priority Data
May 14, 2021 (CN) 202110529086.7

(51) Int. Cl. G08G 1/097; G08G 1/095

(52) U.S. Cl. CPC G08G 1/097; G08G 1/095

(57) ABSTRACT

The present disclosure provides a signal light control method, apparatus and system. The specific implementation includes: acquiring control strategy data for a signal light at an intersection, where the control strategy data represents a control rule for controlling the signal light, and the signal light have a plurality of light heads, and determining light state information of each phase of the signal light according to the control strategy data, where a phase represents a traffic flow of a light head corresponding to the phase within a preset time period, and determining control-related information of each phase according to the light state information of each phase, where the control-related information represents an association relationship between respective light colors of the light head corresponding to the phase, and controlling, according to the control-related information of each phase, the light head corresponding to each phase to display a light color.

### CROSS-REFERENCE TO RELATED APPLICATIONS

This application claims priority to Chinese Patent Application No. 202110529086.7, filed on May 14, 2021, which is hereby incorporated by reference in its entirety.

### TECHNICAL FIELD

The present application relates to the field of intelligent transportation technology in the field of artificial intelligence technology, and in particular to a signal light control method, apparatus and system.

### BACKGROUND

With the widespread application of artificial intelligence technology, the use of intelligent technology to control traffic can provide greater convenience for the travel of vehicles and pedestrians. Signal light control is an important control process in the field of transportation, which may include simulated control of a signal light in a simulated scenario, and control of a signal light in an application scenario, to control the signal light to output light state information.

In prior art, it is necessary to manually read or determine traffic light data (for example, light color, display time), and then input the determined traffic light data into a simulation test device or a controller which controls a signal light.

### SUMMARY

The present application provides a signal light control method, apparatus and system.

A first aspect of the present application provides a signal light control method, including:

acquiring control strategy data for a signal light at an intersection, where the control strategy data represents a control rule for controlling the signal light, and the signal light has a plurality of light heads; and determining, according to the control strategy data, light state information of each phase of the signal light, where a phase represents a traffic flow of a light head corresponding to the phase within a preset time period;

determining, according to the light state information of each phase, control-related information of each phase, where the control-related information represents an association relationship between respective colors of the light head corresponding to the phase; and

controlling, according to the control-related information of each phase, the light head corresponding to each phase to display a light color.

A second aspect of the present application provides an electronic device, including:

at least one processor; and

a memory, communicatively connected with the at least one processor; where

the memory stores instructions executables by the at least one processor, and the instructions are executed by the at least one processor to enable the at least one processor to perform the method described in the first aspect.

A third aspect of the present application provides a non-transitory computer-readable storage medium having computer instructions stored thereon, where the computer instructions are used to cause a computer to perform the method described in the first aspect.

A fourth aspect of the present application provides a signal light control system, including: a signal light which is set at an intersection, and an apparatus as described in the second aspect.

It should be understood that the content described in this section is not intended to identify the key or important features of the embodiments of the present application, nor is it intended to limit the scope of the present application. Other features of the present applications will be readily understood through the following specification.

### BRIEF DESCRIPTION OF DRAWINGS

The drawings are used to better understand the solution, and do not constitute a limitation of the present application, where:

FIG. 1 is a schematic diagram according to a first embodiment of the present application;

FIG. 2 is a schematic scenario diagram of a signal light control method according to an embodiment of the present application;

FIG. 3 is a schematic diagram according to a second embodiment of the present application;

FIG. 4 is a schematic diagram according to a third embodiment of the present application;

FIG. 5 is a schematic diagram according to a fourth embodiment of the present application;

FIG. 6 is a schematic diagram according to a fifth embodiment of the present application;

FIG. 7 is a schematic diagram according to a sixth embodiment of the present application;

FIG. 8 is a block diagram of an electronic device used to implement the signal light control method according to the embodiments of the present application.

### DESCRIPTION OF EMBODIMENTS

Exemplary embodiments of the present application are described below with the drawings, which include various details of the embodiments of the present application to facilitate understanding, and they should be considered as merely exemplary. Therefore, those of ordinary skill in the art should recognize that various changes and modifications may be made to the embodiments described herein without departing from the scope and spirit of the present application. Similarly, for clarity and conciseness, descriptions of well-known functions and structures have been omitted in the following description.

Control of signal lights is an important control process in the field of transportation. Through the control of traffic signal lights, efficiency of travel can be improved, and safety and reliability of travel can be improved.

The scenario of controlling a signal light may include two types of scenarios, one is a simulated scenario, and the other is an application scenario.

Illustratively, the simulated scenario refers to a scenario of a simulation test built based on an application scenario, and the signal light is controlled in the simulated scenario in a simulated way.

For example, based on a signal light and an intersection in an application scenario, a simulated scenario is obtained in a server virtually, and relevant data (control data used to control the signal light) is input into the server to realize the control of a simulated signal light in the simulated scenario. For example, a simulated signal light is controlled to output a light color (such as red light or green light), or for another example, a simulated signal light is controlled to output a countdown of time.

In related technologies, in order to realize the control of a signal light in a simulated scenario, a method usually used includes: downloading traffic lights data from a data provision platform (such as a traffic management platform or a platform of a manufacturer that produces signal lights) by using an intermediate device (such as a computer), and pushing the downloaded traffic lights data in the intermediate device to a simulation test device in a manual way, so that the simulation test device controls the simulated signal light based on the traffic lights data, such as controlling the simulated signal light to output a corresponding light color, etc.

However, combining the intermediate device to push traffic lights data, on the one hand, lacks interaction between the simulation test device and the data provision platform, and a problem of data loss may be caused by abnormal conditions such as failure of the intermediate equipment, thus causing a problem of low accuracy and reliability of the simulation test; on the other hand, because the data obtained is traffic lights data, it is impossible to introduce relevant information of a signal light in the application, such as control strategy data of a signal light, etc., causing that the simulation test is too fixed, and has a large difference from the actual application, and there is a technical problem that the simulation test lacks intuitiveness and reliability.

Illustratively, the application scenario refers to an actual application scenario, such as controlling a signal light which is set at a certain intersection, so that a light head of the signal light outputs a light color, etc.

In relevant technologies, in order to realize the control of a signal light in the application scenario, a method usually used includes: manually determining traffic lights data used to control the signal light, and inputting the traffic lights data into a controller, so that the controller controls the signal light based on the traffic lights data.

However, manual determination of the traffic lights data has a technical problem of low accuracy and time consuming in determining the traffic lights data.

In order to avoid at least one of the above technical problems, the inventors of the present disclosure obtain the inventive concept of the present disclosure through creative efforts: obtaining an association relationship between respective light colors of the light head of each phase (i.e., control-related information) through analyzing control strategy data of the signal light, so as to control the light head to display a light color based on the control-related information.

The present application provides a signal light control method, apparatus, and system, which are a signal light control method, apparatus, and system applied in the field of artificial intelligence technology, to achieve the accuracy and reliability of signal light control.

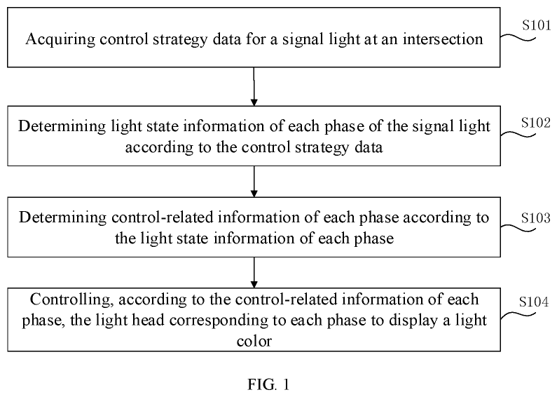

FIG. 1 is a schematic diagram according to a first embodiment of the present application As shown in FIG. 1, the signal light control method provided by the embodiment of the present disclosure includes:

S101: acquiring control strategy data for a signal light at an intersection.

The control strategy data represents a control rule for controlling the signal light, and the signal light has a plurality of light heads.

Illustratively, an executive entity of the present embodiment may be a signal light control apparatus (hereinafter referred to as a control apparatus), and the control apparatus may be a server (including a local server and a cloud server, where the server may be a cloud control platform, a vehicle infrastructure cooperative management platform, a center subsystem, an edge computing platform, a cloud computing platform, etc.), may also be a roadside device, may also be a terminal device, may also be a processor, may also be a chip, etc., which is not limited in this embodiment. The roadside device includes, for example, a roadside sensing device with a computing function, a roadside computing device connected to a roadside sensing device. In a vehicle infrastructure cooperative system architecture of intelligent traffic, the roadside device includes a roadside sensing device and a roadside computing device, and the roadside sensing device (such as a roadside camera) is connected to the roadside computing device (such as a roadside computing unit, RSCU), and the roadside computing device is connected to the server, and the server can communicate with autonomous driving or assisted driving vehicles in various ways; or, if the roadside sensing device itself includes a computing function, the roadside sensing device is directly connected to the server. The above connection may be wired or wireless.

In view of the above analysis, if the signal light control method of the present embodiment is applied to a simulated scenario, the control apparatus may specifically be a simulation test device; if the signal light control method of the present embodiment is applied to an application scenario, the control apparatus may specifically be a controller.

Generally, a plurality of signal lights may be set on an intersection. For example, four signal lights may be set at a crossroads; one signal light has a plurality of light heads, and one light head can display a plurality of colors, such as red, yellow, and green.

For a simulated scenario, this step can be understood as: the simulation test device may determine an intersection which needs to be tested, and obtain the control strategy data of a signal light on the intersection.

One signal light may correspond to one piece of control strategy data or may correspond to different control strategy data at different time periods. That is, the control strategy data of the signal light may be one piece, or be different at different time periods.

For example, since 7:00 to 9:00 is a peak period for work, the traffic flow is relatively high, while the traffic flow from 9:00 to 11:00 is relatively low, so the control strategy data for 7:00 to 9:00 is not the same control strategy data as the control strategy data for 9:00 to 11:00.

It should be understood that the present embodiments do not limit the type of intersection. For example, the intersection may be a crossroads or a T-shaped intersection; the present embodiments do not limit the number of signal lights, and it is possible to control all signal lights at the intersection, or control a part number of signal lights at the intersection, for example, for a simulated scenario, it is possible to control a certain signal light at an intersection, while for an application scenario, it is possible to control each signal light at the intersection.

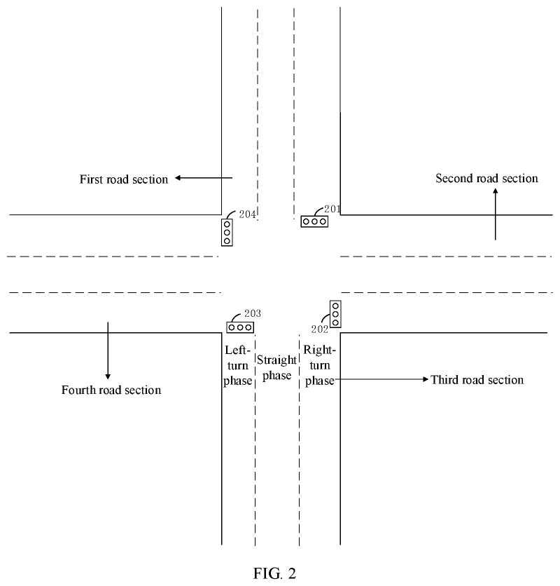

Illustratively, when the signal light control method of the embodiment is aimed at an application scenario, that is, when the signal light control method of the embodiment is used in an application scenario, reference may be made to FIG. 2 for a schematic diagram of the application scenario, which exemplarily shows a scenario where an intersection is a crossroads.

As shown in FIG. 2, the intersection may be composed of a first road section, a second road section, a third road section, and a fourth road section. The first road section and the third road section may be referred to as road sections opposite to each other. The second road section and the fourth road section may be referred to as road sections opposite to each other. A signal light 201 set on the first road section is used to indicate movement of vehicles on the third road section, and a signal light 202 set on the second road section is used to indicate movement of vehicles on the fourth road section. A signal light 203 set on the third road section is used to indicate movement of vehicles on the first road section, and a signal light 204 set on the fourth road section is used to indicate movement of vehicles on the second road section.

In a case of controlling the signal light 201 set on the first road section, this step may be understood as: acquiring the control strategy data of the signal light 201; in a case of controlling the four signal lights on the four road sections, this step may be understood as: acquiring the control strategy data of each of the four signal lights.

S102: determining light state information of each phase of the signal light according to the control strategy data.

A phase represents a traffic flow of a light head corresponding to the phase within a predetermined time period. The light state information may be understood as information of dimensions such as color, time, phase, etc. of a light head. Traffic lights data (e.g., color and time) is part of the light state information.

In view of the above analysis, an intersection may include a plurality of signal lights, and one signal light may include a plurality of light heads, and one light head corresponds to one phase.

For example, if a light head of a signal light is used to instruct a left-turn traffic flow to proceed or stop, then the phase corresponding to the light head is a left-turn phase.

Specifically, in combination with the schematic diagram of the scenario shown in FIG. 2, if the signal light 201 includes three light heads, one is used to instruct the traffic flow in the left-turn phase, one is used to instruct the traffic flow in the straight phase, and one is used to instruct the traffic flow in the right-turn phase.

S103: determining control-related information of each phase according to the light state information of each phase.

The control-related information represents an association relationship between respective light colors of a light head corresponding to a phase.

In combination with the above analysis, one phase corresponds to one light head, and one light head has a plurality of light colors, and accordingly, the control-related information of a certain phase may be understood as: an association relationship between a plurality of light colors of the light head corresponding to the phase, for example, an association relationship between the red light and the green light of the light head corresponding to that phase; or, an association relationship between the red light and the yellow light of the light head corresponding to that phase; or, an association relationship between the red light, the green light, and the yellow light of the light head corresponding to that phase.

S104: controlling a light head corresponding to each phase to display a light color according to the control-related information of each phase.

Based on the above analysis, it can be seen that the present embodiment discloses a signal light control method, including: acquiring control strategy data for a signal light at an intersection, where the control strategy data represents a control rule for controlling the signal light and the signal light has a plurality of light heads, determining light state information of each phase of the signal light according to the control strategy data, where a phase represents a traffic flow of a light head corresponding to the phase within a preset time period, determining control-related information of each phase according to the light state information of each phase, where the control-related information represents an association relationship between respective light colors of the light head corresponding to the phase, and controlling the light head corresponding to each phase to display a light color according to the control-related information of each phase. In the present embodiment, the following features are introduced: the light state information is determined based on the control strategy data, and the control-related information is determined based on the light state information, so that the light head of the signal light is controlled to display a light color according to the control-related information. On one hand, it can be avoided that in a simulated scenario, the data used for a simulation test has a low fit with the actual application, the control strategy data of the signal light in the actual application is not considered, which causes the simulation test to be too fixed and have a large gap with the actual application and lack intuitiveness and reliability; and the simulation test is highly fitted to the actual application and the technical effect of improving test flexibility and reliability is achieved. On the other hand, the problem of low accuracy and time-consuming caused by manually determining the traffic lights data and controlling based on the traffic lights data in the application scenario can be avoided, and the technical effect of improving intelligentization of control and improving accuracy and reliability of control is achieved.

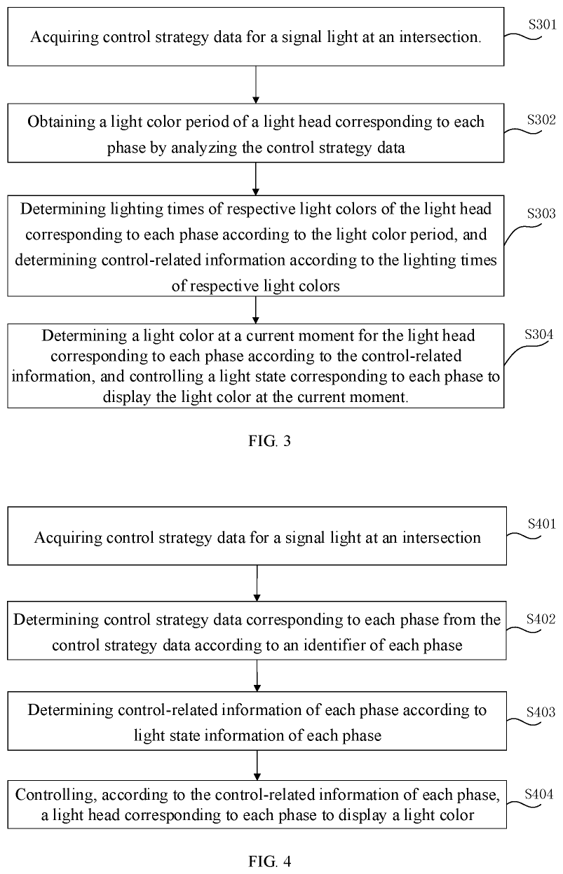

FIG. 3 is a schematic diagram according to a second embodiment of the present application. As shown in FIG. 3, the signal light control method provided by the embodiment of the present disclosure includes:

S301: acquiring control strategy data for a signal light at an intersection.

The control strategy data represents a control rule for controlling the signal light, and the signal light has a plurality of light heads.

Illustratively, for the description of S301, reference may be made to the relevant description of the first embodiment, which will not be repeated here.

In some embodiments, S301 may include: if pre-stored strategy data of the signal light includes optimized strategy data, the optimized strategy data is determined as the control strategy data; if the pre-stored strategy data does not include optimized strategy data, initial strategy data is determined as the control strategy data.

The optimized strategy data is obtained by adjusting the initial strategy data of the intersection based on a historical traveling record of the intersection.

Generally, the initial strategy data is an initialized control rule of a signal light, such as a control rule configured when the signal light leaves the factory, or a control rule assigned to the signal light when the signal light is used for the first time.

The optimized strategy data refers to a control rule which is obtained by adjusting the initial strategy data based on a historical travelling record to meet higher travel demands.

Specifically, the present embodiment may be understood as: the pre-stored strategy data of the signal light may only be the initial strategy data; or, it may include both the initial strategy data and the optimized strategy data.

The control apparatus may determine whether the pre-stored strategy data includes the optimized strategy data and if so, the control apparatus may take the optimized strategy data as the control strategy data, so that the signal light is controlled based on the optimized strategy data; if not, the control apparatus may take the initial strategy data as the control strategy data, so that the signal light is controlled based on the initial strategy data.

It is worth noting that, in this embodiment, by prioritizing the control of the signal light with the optimized control strategy, the control of the signal light can better satisfy travel demands and achieve the technical effect of improving travel efficiency and accuracy.

In addition, when there is no optimized control strategy, by controlling the signal light through the initial control strategy, flexibility and diversity of the control of the signal light can be achieved, and the technical effect of improving the reliability of the control of the signal light can be achieved.

In some other embodiments, the pre-stored strategy data includes the control strategy of the signal light in different time periods (similarly, it may only include the initial control strategy, or it may include both the initial control strategy and the optimized control strategy), and the control apparatus may select the control strategy of a time period to which a current time belongs, based on the current time.

S302: obtaining a light color period of a light head corresponding to each phase, by analyzing the control strategy data.

A phase represents a traffic flow of a light head corresponding to the phase within a preset time period. The light state information of each phase includes the light color period.

Illustratively, for the description of the phase and light state information, reference may be made to the relevant description of the first embodiment, which will not be repeated here.

S303: determining lighting times of respective light colors of the light head corresponding to each phase according to the light color period, and determining the control-related information according to the lighting times of respective light colors.

The control-related information represents an association relationship between respective light colors of the light head corresponding to the phase.

Illustratively, for the description of the control-related information, reference may be made to the relevant description of the first embodiment, which will not be repeated here.

It is worth noting that, in this embodiment, through the analysis of the control strategy data, the light state information—the light color period, of each phase is obtained, so that the control-related information is determined based on the light color period, and the technical effect of improving efficiency and accuracy of the determined control-related information can be achieved.

In some embodiments, S303 may include the following steps:

A first step: determining switching times between respective light colors and a lighting sequence of respective light colors according to the lighting times of respective light colors.

A switching time represents a moment of switching between two different light colors, such as a moment when a red light is switched to a green light, or a moment when a green light is switched to a yellow light, etc.

The lighting sequence represents a sequence in which different light colors are turned on. For example, if a red light is turned on for 30 seconds and then a green light is turned on, the red light is turned on before the green light in the sequence.

In this step, after determining the lighting times of respective light colors, the control apparatus may calculate based on the lighting times of respective light colors, so as to obtain the switching times between respective light colors and the lighting sequence between respective light colors.

A second step: generating control-related information according to the lighting times of respective light colors, the switching times between respective light colors, and the lighting sequence between respective light colors.

Based on the above analysis, the control apparatus can determine the lighting times of respective light colors, the switching times between respective light colors, and the lighting sequence between respective light colors, and based on the lighting times of respective light colors, the switching times between respective light colors and the lighting sequence between the respective light colors, can determine the association relationship between respective light colors, for example, after a green light is turned on for 1 minute, a red light is turned on, and the red light is turned on for 30 seconds, then a yellow light is turned on, the yellow light is turned on for 5 seconds, and then the green light is turned on, and so on, which will not be further listed here.

It is worth noting that in this embodiment, the control-related information can be generated based on the lighting times of respective light colors, the switching times between the light colors, and the lighting sequence between the light colors, which can achieve a high degree of fit of the control-related information with the light state information, thus making the control-related information have a higher expressiveness for the association relationship between the light colors, and achieving the technical effect that the control-related information has higher accuracy and reliability.

S304: determining a light color at a current moment for the light head corresponding to each phase according to the control-related information, and controlling a light state corresponding to each phase to display the light color at the current moment.

Illustratively, the control apparatus may perform instantiation processing based on the control-related information, so as to realize the control of the light state corresponding to each phase to display the light color at the current moment.

For example, the control apparatus may encapsulate the control-related information into a data structure, for example, “1” indicates the direction of the east entrance, and “2” indicates turning on the green light, etc., and instantiate the data structure in order to display the light color at the current moment.

It is worth noting that, in combination with the above analysis, it can be seen that the control-related information has high accuracy and reliability, therefore, in this embodiment, when the light color of the current moment is displayed for the light state of each phase based on the control-related information, the technical effect of improving accuracy and reliability of the light color display can be achieved.

In some embodiments, the control apparatus may also control the light head of the signal light to display a countdown of time. For example, the control apparatus may determine, according to the control-related information, a countdown of time of the light color at the current time for the light head corresponding to each phase, and control the light head corresponding to each phase to display the countdown of time of the light color at the current time.

Similarly, the control apparatus may perform instantiation processing based on the control-related information, so as to control the light state corresponding to each phase to display the light color and the countdown of time at the current moment.

It is worth noting that, in combination with the above analysis, it can be seen that the control-related information has high accuracy and reliability, and thus, in this embodiment, when the countdown of time of the current moment is displayed for the light state corresponding to each phase based on the control-related information, the technical effect of improving accuracy and reliability in displaying the countdown of time can be achieved, and when the control apparatus controls the display of the light color and the countdown of time, the technical effect of improving diversity and flexibility of controlling the light state can be achieved.

FIG. 4 is a schematic diagram according to a third embodiment of the present application. As shown in FIG. 4, the signal light control method provided by the embodiment of the present disclosure includes:

S401: acquiring control strategy data for a signal light at an intersection.

The control strategy data represents a control rule for controlling the signal light, and the signal light has a plurality of light heads.

Illustratively, for the description of S401, reference may be made to the relevant description of the first embodiment, or the relevant description of the second embodiment, which will not be repeated here.

S402: determining control strategy data corresponding to each phase from the control strategy data according to an identifier of each phase.

Each phase has an identifier, and a phase represents a traffic flow of a light head corresponding to the phase within a preset time period.

In combination the above analysis, one signal light may include a plurality of light heads, and one light head may correspond to one phase, for example, a certain light head of the signal light represents a left-turn phase.

In this embodiment, phases can be distinguished based on their respective identifiers, and the control strategy data of a phase corresponding to an identifier can be determined from the control strategy data through the identifier.

It is worth noting that, in this embodiment, the control strategy data of a phase corresponding to an identifier is determined from the control strategy data by the identifier, through which the technical effect of improving efficiency and accuracy in determining the control strategy data of the phase can be achieved.

S403: determining control-related information of each phase according to light state information of each phase.

The control-related information represents an association relationship between respective light colors of a light head corresponding to a phase.

S404: controlling a light head corresponding to each phase to display a light color according to the control-related information of each phase.

Illustratively, for the description of S403 and S404, reference may be made to the relevant description of the first embodiment, and reference may also be made to the relevant description of the second embodiment, which will not be repeated here.

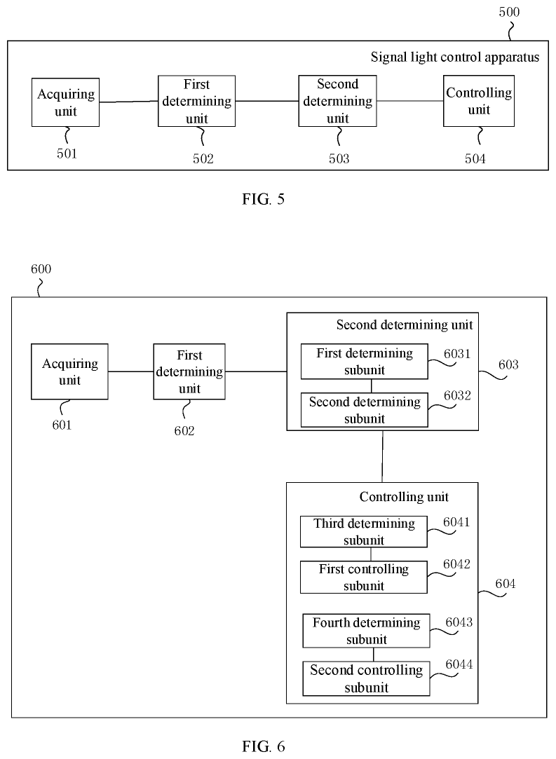

FIG. 5 is a schematic diagram according to a fourth embodiment of the present application. As shown in FIG. 5, the signal light control apparatus provided by the embodiment of the present disclosure includes:

An acquiring unit 501, configured to acquire control strategy data of a signal light at an intersection, where the control strategy data represents a control rule for controlling the signal light, and the signal light has a plurality of light heads.

A first determining unit 502, configured to determine light state information of each phase of the signal light according to the control strategy data, where a phase represents a traffic flow of a light head corresponding to the phase within a preset time period.

A second determining unit 503, configured to determine control-related information of each phase according to the light state information of each phase, where the control-related information represents an association relationship between respective light colors of the light head corresponding to the phase.

A controlling unit 504, configured to control the light head corresponding to each phase to display a light color according to the control-related information of each phase.

FIG. 6 is a schematic diagram according to a fifth embodiment of the present application As shown in FIG. 6, the signal light control apparatus provided by the embodiment of the present disclosure includes:

An acquiring unit 601, configured to acquire control strategy data for a signal light at an intersection, where the control strategy data represents a control rule for controlling the signal light, and the signal light has a plurality of light heads.

In some embodiments, the acquiring unit 601 is configured to, if pre-stored strategy data of the signal light includes optimized strategy data, determine the optimized strategy data as the control strategy data, where the optimized strategy data is obtained by adjusting initial strategy data of the intersection based on a historical travelling record of the intersection.

In some embodiments, the acquiring unit 601 is configured to determine the initial strategy data as the control strategy data if the optimized strategy data is not included in the pre-stored strategy data.

A first determining unit 602, configured to determine light state information of each phase of the signal light according to the control strategy data, where a phase represents a traffic flow of a light head corresponding to the phase within a preset time period.

A second determining unit 603, configured to determine control-related information of each phase according to the light state information of each phase, where the control-related information represents an association relationship between respective light colors of the light head corresponding to the phase.

As can be seen with reference to FIG. 6, in some embodiments, the second determining unit 603 includes:

A first determining subunit 6031, configured to determine lighting times of respective light colors of the light head corresponding to each phase according to a light color period.

A second determining subunit 6032, configured to determine the control-related information according to the lighting times of respective light colors.

In some embodiments, the second determining subunit 6032 includes:

A determining module, configured to determine switching times between respective light colors and a lighting sequence between respective light colors according to the lighting times of respective light colors.

A generating module, configured to generate the control-related information according to the lighting times of respective light colors, the switching times between respective light colors, and the lighting sequence between respective light colors.

A controlling unit 604, configured to control the light head corresponding to each phase to display a light color according to the control-related information of each phase.

As can be seen with reference to FIG. 6, in some embodiments, the controlling unit 604 includes:

A third determining subunit 6041, configured to determine a light color at a current moment for the light head corresponding to each phase according to the control-related information.

A first controlling subunit 6042, configured to control a light state corresponding to each phase to display the light color at the current moment.

A fourth determining subunit 6043, configured to determine, according to the control-related information, a countdown of time of the light color at the current moment for the light head corresponding to each phase.

A second controlling subunit 6044, configured to control the light head corresponding to each phase to display the countdown of time of the light color at the current moment.

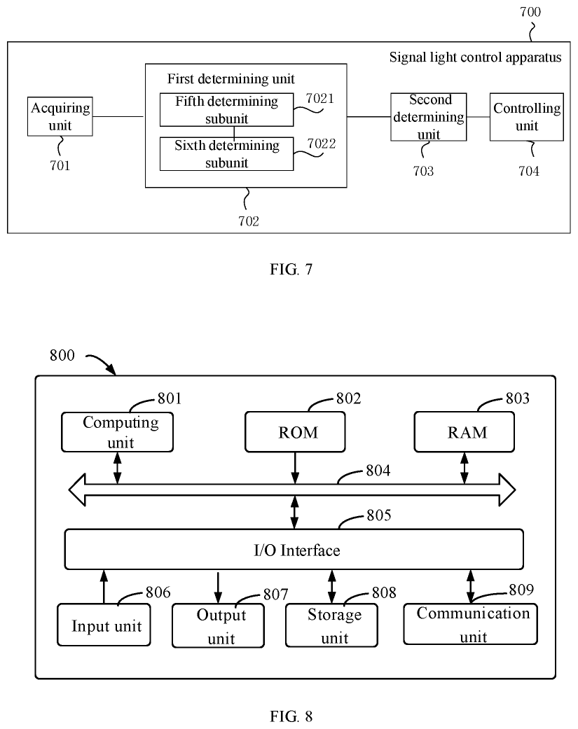

FIG. 7 is a schematic diagram according to a sixth embodiment of the present application. As shown in FIG. 7, the signal light control apparatus provided by the embodiment of the present disclosure includes:

An acquiring unit 701, configured to acquire control strategy data for a signal light at an intersection, where the control strategy data represents a control rule for controlling the signal light, and the signal light has a plurality of light heads.

A first determining unit 702, configured to determine light state information of each phase of the signal light according to the control strategy data, where a phase represents a traffic flow of a light head corresponding to the phase within a preset time period.

In some embodiments, each phase has an identifier; the first determining unit 702 includes:

A fifth determining subunit 7021, configured to determine the control strategy data corresponding to each phase from the control strategy data according to the identifier of each phase.

A sixth determining subunit 7022, configured to determine the light state information of each phase according to the control strategy data corresponding to each phase.

A second determining unit 703, configured to determine control-related information of each phase according to the light state information of each phase, where the control-related information represents an association relationship between respective light colors of the light head corresponding to the phase.

A controlling unit 704, configured to control, according to the control-related information of each phase, the light head corresponding to each phase to display a light color.

According to an embodiment of the present application, the present application also provides an electronic device and a readable storage medium.

According to an embodiment of the present application, the present application also provides a computer program product, the computer program product includes a computer program, the computer program is stored in a readable storage medium, and at least one processor of an electronic device can read the computer program from the readable storage medium, and the at least one processor executes the computer program to cause the electronic device to perform the solution provided by any of the above embodiments.

FIG. 8 illustrates a schematic block diagram of an example electronic device 800 that may be used to implement embodiments of the present application. The electronic device is intended to represent various forms of a digital computers, such as, a laptop, a desktop computer, a workstation, a personal digital assistant, a server, a blade server, a mainframe computer, and other suitable computers. The electronic device may also represent various forms of a mobile devices, such as a personal digital assistant, a cellular phone, a smartphone, a wearable device, and other similar computing devices. The components shown herein, their connections and relationships, and their functions are merely examples, but are not intended to limit the implementation of the present disclosure described and/or claimed herein.

As shown in FIG. 8, the electronic device 800 includes a computing unit 801, which can perform various appropriate actions and processing according to a computer program stored in a read-only memory (ROM) 802 or loaded into a random access memory (RAM) 803 from a storage unit 808. In RAM 803, various programs and data required for the operation of device 800 may also be stored. The computing unit 801, ROM 802, and RAM 803 are connected to each other through a bus 804. An input/output (I/O) interface 805 is also connected to the bus 804.

A plurality of components in the device 800 is connected to the I/O interface 805, including: input unit 806, such as a keyboard, a mouse, etc.; output unit 807, such as various types of monitors, speakers, etc.; a storage unit 808, such as a disk, a CD-ROM, etc.; and a communication unit 809, such as a network card, a modem, a wireless communication transceiver, etc. The communication unit 809 allows the device 800 to exchange information/data with other devices via a computer network such as the Internet and/or various telecommunications networks.

The computing unit 801 may be a variety of general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processors, controllers, microcontrollers, etc. The computing unit 801 performs the various methods and processes described above, for example, the signal light control method. For example, in some embodiments, the signal light control method may be implemented as a computer software program, which is tangibly contained in a machine-readable medium, for example the memory unit 808. In some embodiments, some or all of the computer programs may be loaded and/or installed onto the device 800 via the ROM 802 and/or the communication unit 809. When the computer program is loaded into the RAM 803 and executed by the computing unit 801, one or more steps of the signal light control method as described above may be performed. Alternatively, in other embodiments, the computing unit 801 may be configured to perform the signal light control method by any other appropriate means (e.g., with the aid of firmware).

Various implementations of the systems and techniques described above herein may be implemented in a digital electronic circuit system, an integrated circuit system, a field-programmable gate array (FPGA), an application-specific integrated circuit (ASIC), an application-specific standard product (ASSP), a systems-on-a-chip (SOC), a complex programmable logic device (CPLD), computer hardware, firmware, software, and/or their combinations. These various implementations may include: implementing in one or more computer programs that may be executed and/or interpreted on a programmable system including at least one programmable processor, where the programmable processor may be a special-purpose or general-purpose programmable processor that may receive data and instructions from a storage system, at least one input device, and at least one output device, and transfer data and instructions to the storage system, the at least one input device, and the at least one output device.

Program code for implementing the methods of the present disclosure may be written in any combination of one or more programming languages. The program code may be provided to a processor or controller of a general-purpose computer, a special-purpose computer, or other programmable data processing device so that the program code, when executed by the processor or controller, causes the functions/operations specified in the flowchart and/or block diagram to be implemented. The program code may be executed entirely on a machine or partially on a machine, partially on a machine and partially on a remote machine as stand-alone software packages, or entirely on a remote machine or server.

In the context of the present disclosure, a machine-readable medium may be a tangible medium that may contain or store a program for use by or in conjunction with an instruction-executing system, device, or apparatus. The machine-readable medium may be a machine-readable signal medium or a machine-readable storage medium. The machine-readable medium may include, but are not limited to, an electronic, magnetic, optical, electromagnetic, infrared, or semiconductor system, device, or equipment, or any suitable combination of the above. More specific examples of the machine-readable storage medium would include electrical connections based one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

In order to provide interaction with a user, the systems and techniques described herein may be implemented on a computer having: a display device (e.g., a cathode ray tube (CRT) or liquid crystal display (LCD) monitor) for displaying information to the user; and a keyboard and pointing device (e.g., a mouse or trackball) through which the user can provide input to the computer. Other types of devices may also be used to provide interaction with the user; for example, feedback provided to the user may be any form of sensory feedback (e.g., visual feedback, auditory feedback, or tactile feedback); and the input from the user may be received in any form (including acoustic input, voice input, or tactile input).

The systems and techniques described herein may be implemented in a computing system including a back-end component (e.g., as a data server), or a computing system including a middleware component (e.g., an application server), or a computing system including a front-end component (e.g., a user computer having a graphical user interface or a web browser through which the user can interact with the implementations of the technologies and the systems described herein), or a computing system including any combination of such back-end component, middleware component, or front-end component. The components of the system may be interconnected via any form or medium of digital data communication (e.g., a communication network). Examples of the communication network include: a local area network (LAN), a wide area network (WAN), and the Internet.

A computer system may include a client and a server. The client and server are generally remote from each other and typically interact over a communication network. The client-server relationship is generated by computer programs that run on corresponding computers and have a client-server relationship with each other. The server may be a cloud server, also known as a cloud computing server or cloud host, which is a hosting product in the cloud computing service system to solve the defects of difficult management and weak business scalability in the traditional physical host and Virtual Private Server (or simply “VPS”). The server may also be a server of a distributed system, or a server incorporating a blockchain.

According to another aspect of embodiments of the present disclosure, an embodiment of the present disclosure also provide a signal light control system, including: a signal light, and a signal light control apparatus as described in any of the above embodiments.

It should be understood that various forms of processing shown above may be used to reorder, add, or remove a step. For example, the steps described in this application may be performed in parallel or sequentially or in a different order, as long as the desired results of the technical solutions disclosed in this application are achieved, which is not limited herein.

The above specific embodiments do not constitute a limitation of the scope of protection of this application. It should be understood by those skilled in the art that various modifications, combinations, sub-combinations and substitutions may be made according to design requirements and other factors. Any modifications, equivalent substitutions and improvements, etc. made within the spirit and principles of this application shall be covered in the scope of protection of this application.

What is claimed is:

1. A signal light control method, comprising:
acquiring control strategy data for a signal light at an intersection, wherein the control strategy data represents a control rule for controlling the signal light, and the signal light have a plurality of light heads; and determining, according to the control strategy data, light state information of each phase of the signal light, wherein a phase represents a traffic flow of a light head corresponding to the phase within a preset time period;
determining, according to the light state information of the each phase, control-related information of the each phase, wherein the control-related information represents an association relationship between respective light colors of the light head corresponding to the phase; and
controlling, according to the control-related information of the each phase, the light head corresponding to the each phase to display a light color.

2. The method according to claim 1, wherein determining, according to the control strategy data, the light state information of the each phase of the signal light, comprises:
obtaining a light color period of the light head corresponding to the each phase by analyzing the control strategy data, wherein the light state information of the each phase includes the light color period.

3. The method according to claim 2, wherein determining, according to the light state information of the each phase, the control-related information of the each phase, comprises:
determining lighting times of respective light colors of the light head corresponding to the each phase according to the light color period, and determining the control-related information according to the lighting times of the respective light colors.

4. The method according to claim 3, wherein determining the control-related information according to the lighting times of the respective light colors comprises:
determining, according to the lighting times of the respective light colors, switching times between the respective light colors and a lighting sequence between the respective light colors, and generating the control-related information according to the lighting times of the respective light colors, the switching times between the respective light colors, and the lighting sequence between the respective light colors.

5. The method according to claim 4, wherein controlling, according to the control-related information of the each phase, the light head corresponding to the each phase to display a light color, comprises:
determining, according to the control-related information, a light color at the current moment for the light head corresponding to the each phase, and controlling a light state corresponding to the each phase to display the light color at the current moment.

6. The method according to claim 5, further comprising:
determining, according to the control-related information, a countdown of time of the light color at the current moment for the light head corresponding to the each phase, and controlling the light head corresponding to the each phase to display the countdown of time of the light color at the current moment.

7. The method according to claim 1, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

8. The method according to claim 2, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

9. The method according to claim 3, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

10. The method according to claim 4, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

11. The method according to claim 5, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

12. The method according to claim 6, wherein the each phase has an identifier; and determining, according to the control strategy data, the light state information of each phase of the signal light, comprises:
determining, from the control strategy data and according to the identifier of the each phase, control strategy data corresponding to the each phase; and
determining the light state information of the each phase according to the control strategy data corresponding to the each phase.

13. The method according to claim 1, wherein acquiring the control strategy data for the signal light at the intersection, comprises:
if pre-stored strategy data of the signal light includes optimized strategy data, determining the optimized strategy data as the control strategy data; wherein the optimized strategy data is obtained by adjusting initial strategy data of the intersection based on a historical traveling record of the intersection.

14. The method according to claim 2, wherein acquiring the control strategy data for the signal light at the intersection, comprises:
if pre-stored strategy data of the signal light includes optimized strategy data, determining the optimized strategy data as the control strategy data; wherein the optimized strategy data is obtained by adjusting initial strategy data of the intersection based on a historical traveling record of the intersection.

15. The method according to claim 3, wherein acquiring the control strategy data for the signal light at the intersection, comprises:
if pre-stored strategy data of the signal light includes optimized strategy data, determining the optimized strategy data as the control strategy data; wherein the optimized strategy data is obtained by adjusting initial strategy data of the intersection based on a historical traveling record of the intersection.

16. The method according to claim 4, wherein acquiring the control strategy data for the signal light at the intersection, comprises:
if pre-stored strategy data of the signal light includes optimized strategy data, determining the optimized strategy data as the control strategy data; wherein the optimized strategy data is obtained by adjusting initial strategy data of the intersection based on a historical traveling record of the intersection.

17. The method according to claim 13, further comprising:
if the pre-stored strategy data does not include optimized strategy data, determining the initial strategy data as the control strategy data.

18. An electronic device, comprising:
at least one processor; and
a memory communicatively connected to the at least one processor; wherein,
the memory stores instructions executable by the at least one processor, and the instructions, when executed by the at least one processor, cause the at least one processor to:
acquire control strategy data of a signal light at an intersection, wherein the control strategy data represents a control rule for controlling the signal light, and the signal light has a plurality of light heads;
determine, according to the control strategy data, light state information of each phase of the signal light, wherein a phase represents a traffic flow of a light head corresponding to the phase within a preset time period;
determine, according to the light state information of the each phase, control-related information of the each phase, wherein the control-related information represents an association relationship between respective light colors of the light head corresponding to the phase; and
control, according to the control-related information of the each phase, the light head corresponding to the each phase to display a light color.

19. A non-transitory computer readable storage medium having computer instructions stored thereon, wherein the computer instructions are used to cause a computer to perform the following steps:
acquire control strategy data of a signal light at an intersection, wherein the control strategy data represents a control rule for controlling the signal light, and the signal light has a plurality of light heads;
determine, according to the control strategy data, light state information of each phase of the signal light, wherein a phase represents a traffic flow of a light head corresponding to the phase within a preset time period;
determine, according to the light state information of the each phase, control-related information of the each phase, wherein the control-related information represents an association relationship between respective light colors of the light head corresponding to the phase; and
control, according to the control-related information of the each phase, the light head corresponding to the each phase to display a light color.

20. A signal light control system, comprising: a signal light which is set at an intersection, and an electronic device according to claim 18.
